(19) United States
(12) Patent Application Publication
(10) Pub. No.: US 2024/0329832 A1
(43) Pub. Date: Oct. 3, 2024

(54) FAST FILLING OF SOLID STATE DRIVES

(71) Applicant: International Business Machines Corporation, Armonk, NY (US)

(72) Inventors: Jenny L. Brown, Houston, TX (US); James Kesley Richardson, Houston, TX (US); Nehal Shah, Richmond, TX (US); Aaron Daniel Fry, Richmond, TX (US)

(73) Assignee: International Business Machines Corporation, Armonk, NY (US)

(21) Appl. No.: 18/128,800

(22) Filed: Mar. 30, 2023

(51) Int. Cl. G06F 3/06

(52) U.S. Cl. CPC G06F 3/0604; G06F 3/0653; G06F 3/0679

(57) ABSTRACT

In one general embodiment, a computer-implemented method includes receiving specification of an amount of drive space in a solid state drive (SSD) to emulate, the specified amount being less than all of the drive space of the SSD. The SSD is formatted such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

### BACKGROUND

The present invention relates to data storage systems, and more particularly, this invention relates to partially filling a solid state drive in a manner that emulates a full solid state drive for reducing testing time.

Using Flash memory as an example, the performance characteristics of conventional NAND Flash-based solid state drives (SSDs) are fundamentally different from those of traditional hard disk drives (HDDs). Data in conventional SSDs is typically organized in pages of 4, 8, or 16 KB sizes. Moreover, page read operations in SSDs are typically one order of magnitude faster than write operations and latency neither depends on the current nor the previous location of operations.

However, in Flash-based SSDs, memory locations are erased in blocks prior to being written to. The size of an erase block unit is anywhere from 256, to 512, or even several thousands of pages and the erase operations takes approximately one order of magnitude more time than a page program operation. Due to the intrinsic properties of NAND Flash, Flash-based SSDs write data out-of-place whereby a mapping table maps logical addresses of the written data to physical ones. This mapping table is typically referred to as the Logical-to-Physical Table (LPT).

As Flash-based memory cells exhibit read errors and/or failures due to wear or other reasons, additional redundancy may be used within memory pages as well as across memory chips (e.g., RAID-5 and RAID-6 like schemes). The additional redundancy within memory pages may include error correction code (ECC) which, for example, may include BCH, LDPC, or other codes. While the addition of ECC in pages is relatively straightforward, the organization of memory blocks into RAID-like stripes is more complex. For instance, individual blocks are retired over time which requires either reorganization of the stripes, or capacity reduction of the stripe. As the organization of stripes together with the LPT defines the placement of data, SSDs typically utilize a Log-Structured Array (LSA) architecture, which combines these two methods.

The LSA architecture relies on out-of-place writes. In this approach, a memory page overwrite will result in writing the memory page data to a new location in memory, marking the old copy of the memory page data as invalid, and then updating the mapping information. Due to the limitations of current NAND memory technology, an invalidated data location cannot be reused until the entire block it belongs to has been erased. Before erasing, though, the block undergoes garbage collection, whereby any valid data in the block is relocated to a new block. Garbage collection of a block is typically deferred for as long as possible to maximize the amount of invalidated data in block, and thus reduce the number of valid pages that are relocated, as relocating data causes additional write operations, and thereby increases write amplification.

### SUMMARY

A computer-implemented method, in accordance with one embodiment, includes receiving specification of an amount of drive space in a solid state drive (SSD) to emulate, the specified amount being less than all of the drive space of the SSD. The SSD is formatted such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

A system, in accordance with one embodiment, includes a plurality of non-volatile random access memory (NVRAM) blocks configured to store data, and a processor and logic integrated with and/or executable by the processor. The logic is configured to receive specification of an amount of drive space in a solid state drive (SSD) to emulate, the specified amount being less than all of the drive space of the SSD. The logic is also configured to format the SSD such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

A computer program product, in accordance with one embodiment, includes one or more computer readable storage media, and program instructions collectively stored on the one or more computer readable storage media. The program instructions include program instructions to receive specification of an amount of drive space in a solid state drive (SSD) to emulate, the specified amount being less than all of the drive space of the SSD. Also present are program instructions to format the SSD such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a network architecture, in accordance with one embodiment.

FIG. 3 is a representative hardware environment that may be associated with the servers and/or clients of FIG. 2, in accordance with one embodiment.

FIG. 4 is a diagram of a tiered data storage system, in accordance with one embodiment of the present invention.

FIG. 5 is a diagram of a non-volatile memory card, in accordance with one embodiment.

FIG. 6 is a diagram of a data storage system architecture, in accordance with one embodiment.

FIG. 7 is a system diagram, in accordance with one embodiment.

FIG. 8 is a conceptual diagram which includes a block-stripe and page-stripe, in accordance with one embodiment.

FIG. 9 is a flowchart of a method, in accordance with one embodiment.

FIG. 10 is a flowchart of a method, in accordance with one embodiment.

FIG. 11 is a chart depicting an exemplary the timeline of the method of FIG. 10.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of data storage systems, as well as operation and/or component parts thereof. It should be appreciated that various embodiments herein can be implemented with a wide range of memory mediums, including for example non-volatile random access memory (NVRAM) technologies such as NAND Flash memory, NOR Flash memory, phase-change memory (PCM), magnetoresistive RAM (MRAM) and resistive RAM (RRAM). To provide a context, and solely to assist the reader, various embodiments may be described with reference to a type of non-volatile memory. This has been done by way of example only, and should not be deemed limiting on the invention defined in the claims.

In one general embodiment, a computer-implemented method includes receiving specification of an amount of drive space in a solid state drive (SSD) to emulate, the specified amount being less than all of the drive space of the SSD. The SSD is formatted such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

In another general embodiment, a system includes a plurality of non-volatile random access memory (NVRAM) blocks configured to store data, and a processor and logic integrated with and/or executable by the processor. The logic is configured to receive specification of an amount of drive space in a solid state drive (SSD) to emulate, the specified amount being less than all of the drive space of the SSD. The logic is also configured to format the SSD such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

In another general embodiment, a computer program product includes one or more computer readable storage media, and program instructions collectively stored on the one or more computer readable storage media. The program instructions include program instructions to receive specification of an amount of drive space in a solid state drive (SSD) to emulate, the specified amount being less than all of the drive space of the SSD. Also present are program instructions to format the SSD such that only a number of blocks that provides the specified amount of drive space are made available, and the other blocks are skipped. The available blocks are distributed substantially evenly across planes of the SSD. A presented amount of drive space of the SSD corresponds to the specified amount of drive space. Parameters of the SSD that are dependent upon capacity are scaled based on the specified amount of drive space relative to an actual amount of drive space of the SSD.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code for filling an SSD by a predetermined amount in block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

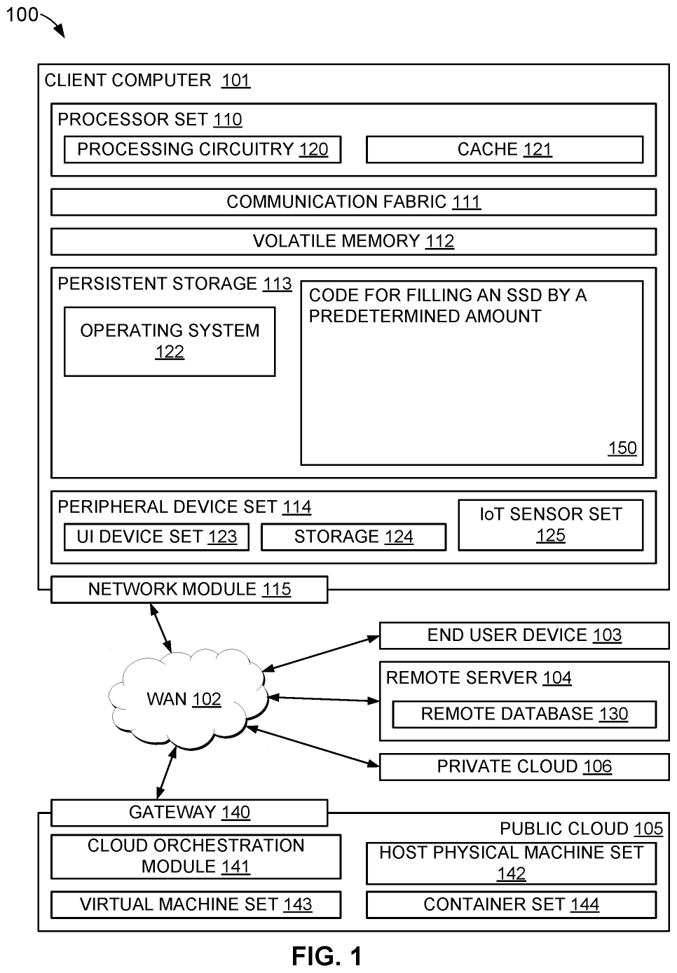

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

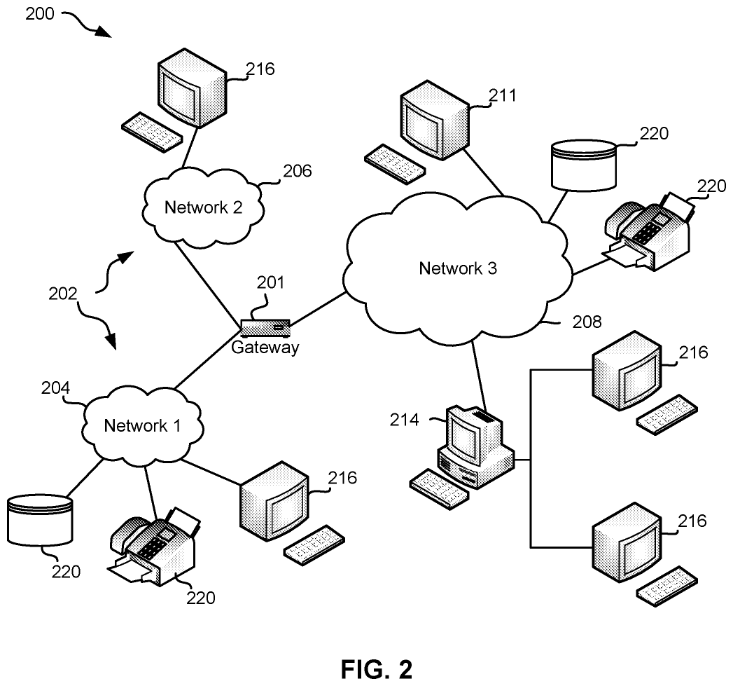

FIG. 2 illustrates a network architecture 200, in accordance with one embodiment. As shown in FIG. 2, a plurality of remote networks 202 are provided including a first remote network 204 and a second remote network 206. A gateway 201 may be coupled between the remote networks 202 and a proximate network 208. In the context of the present network architecture 200, the networks 204, 206 may each take any form including, but not limited to a LAN, a WAN such as the Internet, public switched telephone network (PSTN), internal telephone network, etc.

In use, the gateway 201 serves as an entrance point from the remote networks 202 to the proximate network 208. As such, the gateway 201 may function as a router, which is capable of directing a given packet of data that arrives at the gateway 201, and a switch, which furnishes the actual path in and out of the gateway 201 for a given packet.

Further included is at least one data server 214 coupled to the proximate network 208, and which is accessible from the remote networks 202 via the gateway 201. It should be noted that the data server(s) 214 may include any type of computing device/groupware. Coupled to each data server 214 is a plurality of user devices 216. Such user devices 216 may include a desktop computer, laptop computer, handheld computer, printer, and/or any other type of logic-containing device. It should be noted that a user device 211 may also be directly coupled to any of the networks, in some embodiments.

A peripheral 220 or series of peripherals 220, e.g., facsimile machines, printers, scanners, hard disk drives, networked and/or local data storage units or systems, etc., may be coupled to one or more of the networks 204, 206, 208. It should be noted that databases and/or additional components may be utilized with, or integrated into, any type of network element coupled to the networks 204, 206, 208. In the context of the present description, a network element may refer to any component of a network.

According to some embodiments, methods and systems described herein may be implemented with and/or on virtual systems and/or systems which emulate one or more other systems, such as a UNIX® system which virtually hosts an operating system environment, etc. This virtualization and/or emulation may be enhanced through the use of VMware® software, in some embodiments.

In other embodiments, one or more networks 204, 206, 208, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used, as known in the art.

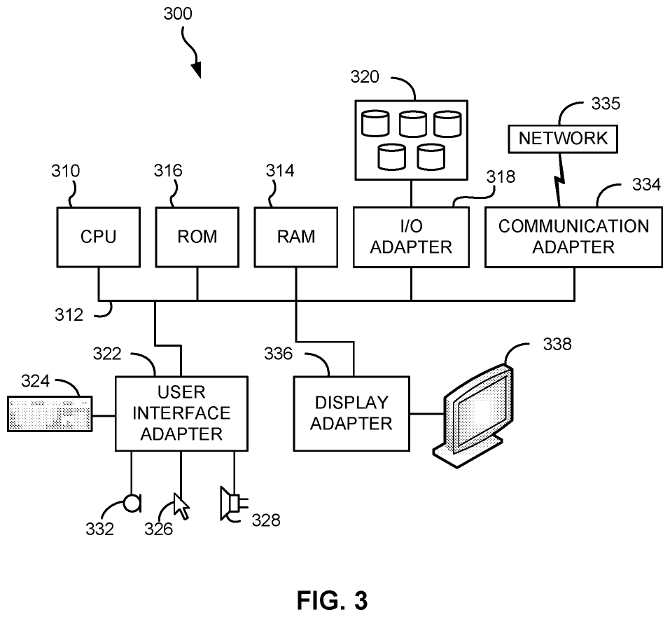

FIG. 3 shows a representative hardware environment associated with a user device 216 and/or server 214 of FIG. 2, in accordance with one embodiment. FIG. 3 illustrates a typical hardware configuration of a processor system 300 having a central processing unit 310, such as a microprocessor, and a number of other units interconnected via a system bus 312, according to one embodiment. In some embodiments, central processing unit 310 may include any of the approaches described above with reference to the processor set 110 of FIG. 1.

The processor system 300 shown in FIG. 3 includes a Random Access Memory (RAM) 314, Read Only Memory (ROM) 316, and an I/O adapter 318 of conventional type. Referring still to processor system 300 of FIG. 3, the aforementioned components 314, 316, 318 may be used for connecting peripheral devices such as storage subsystem 320 to the bus 312. In some embodiments, storage subsystem 320 may include a similar and/or the same configuration as data storage system 220 of FIG. 2. According to an example, which is in no way intended to limit the invention, storage subsystem 320 may include non-volatile data storage cards, e.g., having NVRAM memory cards, RAM, ROM, and/or some other known type of non-volatile memory, in addition to RAID controllers as illustrated in FIG. 2.

With continued reference to FIG. 3, a user interface adapter 322 for connecting a keyboard 324, a mouse 326, a speaker 328, a microphone 332, and/or other user interface devices such as a touch screen, a digital camera (not shown), etc., to the bus 312.

Processor system 300 further includes a communication adapter 334 which connects the processor system 300 to a communication network 335 (e.g., a data processing network) and a display adapter 336 which connects the bus 312 to a display device 338.

The processor system 300 may have resident thereon an operating system of any known type. It will be appreciated that a preferred embodiment may also be implemented on platforms and operating systems other than those mentioned. A preferred embodiment may be written using Java®, XML, C, and/or C++ language, or other programming languages, along with an object oriented programming methodology. Object oriented programming (OOP), which has become increasingly used to develop complex applications, may be used.

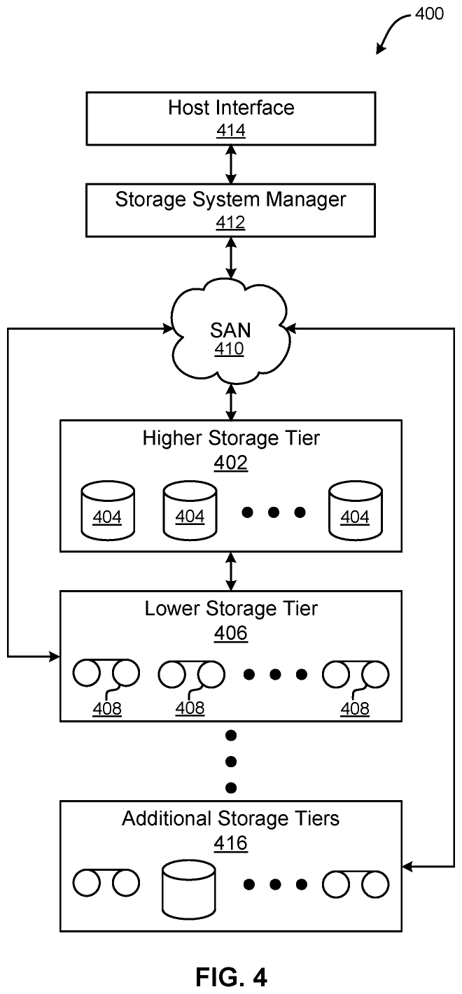

Moreover, FIG. 4 illustrates a storage system 400 which implements high level (e.g., SSD) storage tiers in combination with lower level (e.g., magnetic tape) storage tiers, according to one embodiment. Note that some of the elements shown in FIG. 4 may be implemented as hardware and/or software, according to various embodiments. The storage system 400 may include a storage system manager 412 for communicating with a plurality of media on at least one higher storage tier 402 and at least one lower storage tier 406. However, in other approaches, a storage system manager 412 may communicate with a plurality of media on at least one higher storage tier 402, but no lower storage tier. The higher storage tier(s) 402 preferably may include one or more random access and/or direct access media 404, such as hard disks, nonvolatile memory (NVM), NVRAM), solid state memory in SSDs, flash memory, SSD arrays, flash memory arrays, etc., and/or others noted herein or known in the art. According to illustrative examples, FIGS. 3-4 show exemplary architectures of SSD systems which may be used as a higher storage tier 402 depending on the desired embodiment.

Referring still to FIG. 4, the lower storage tier(s) 406 preferably includes one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Thus, the one or more additional storage tiers 416 may, in some approaches, include a SSD system architecture similar or the same as those illustrated in the FIGS. Described below. Also, any of the higher storage tiers 402 and/or the lower storage tiers 406 may include any combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the embodiments presented herein.

According to some embodiments, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

Of course, this logic may be implemented as a method on any device and/or system or as a computer program product, according to various embodiments.

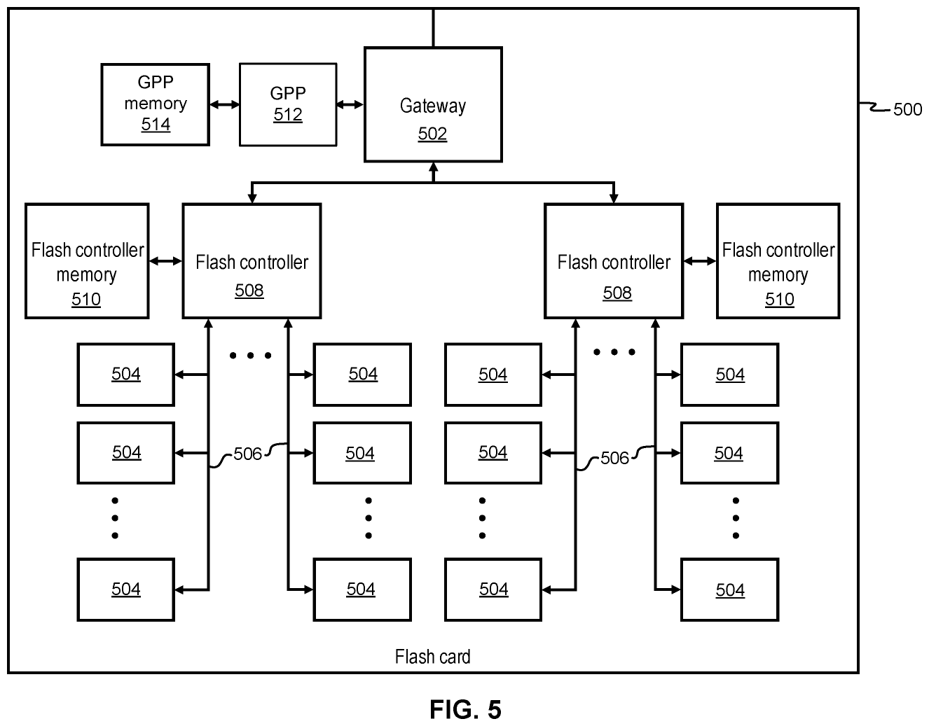

FIG. 5 illustrates a memory card 500, in accordance with one embodiment. It should be noted that although memory card 500 is depicted as an exemplary non-volatile data storage card in the present embodiment, various other types of non-volatile data storage cards may be used in a data storage system according to alternate embodiments. It follows that the architecture and/or components of memory card 500 are in no way intended to limit the invention, but rather have been presented as a non-limiting example.

Moreover, as an option, the present memory card 500 may be implemented in conjunction with features from any other embodiment listed herein, such as those described with reference to the other FIGS. However, such memory card 500 and others presented herein may be used in various applications and/or in permutations which may or may not be specifically described in the illustrative embodiments listed herein. Further, the memory card 500 presented herein may be used in any desired environment.

With continued reference to FIG. 5, memory card 500 includes a gateway 502, a general purpose processor (GPP) 512 (such as an ASIC, FPGA, CPU, etc.) connected to a GPP memory 514 (which may comprise RAM, ROM, battery-backed DRAM, phase-change memory PC-RAM, MRAM, STT-MRAM, etc., or a combination thereof), and a number of memory controllers 508, which include Flash controllers in the present example. Each memory controller 508 is connected to a plurality of NVRAM memory modules 504 (which may comprise NAND Flash or other non-volatile memory type(s) such as those listed above) via channels 506.

According to various embodiments, one or more of the controllers 508 may be or include one or more processors, and/or any logic for controlling any subsystem of the memory card 500. For example, the controllers 508 typically control the functions of NVRAM memory modules 504 such as, data writing, data recirculation, data reading, etc. The controllers 508 may operate using logic known in the art, as well as any logic disclosed herein, and thus may be considered as a processor for any of the descriptions of non-volatile memory included herein, in various embodiments.

Moreover, the controller 508 may be configured and/or programmable to perform or control some or all of the methodology presented herein. Thus, the controller 508 may be considered to be configured to perform various operations by way of logic programmed into one or more chips, modules, and/or blocks; software, firmware, and/or other instructions being available to one or more processors; etc., and combinations thereof.

Referring still to FIG. 5, each memory controller 508 is also connected to a controller memory 510 which preferably includes a cache which replicates a non-volatile memory structure according to the various embodiments described herein. However, depending on the desired embodiment, the controller memory 510 may be battery-backed DRAM, phase-change memory PC-RAM, MRAM, STT-MRAM, etc., or a combination thereof.

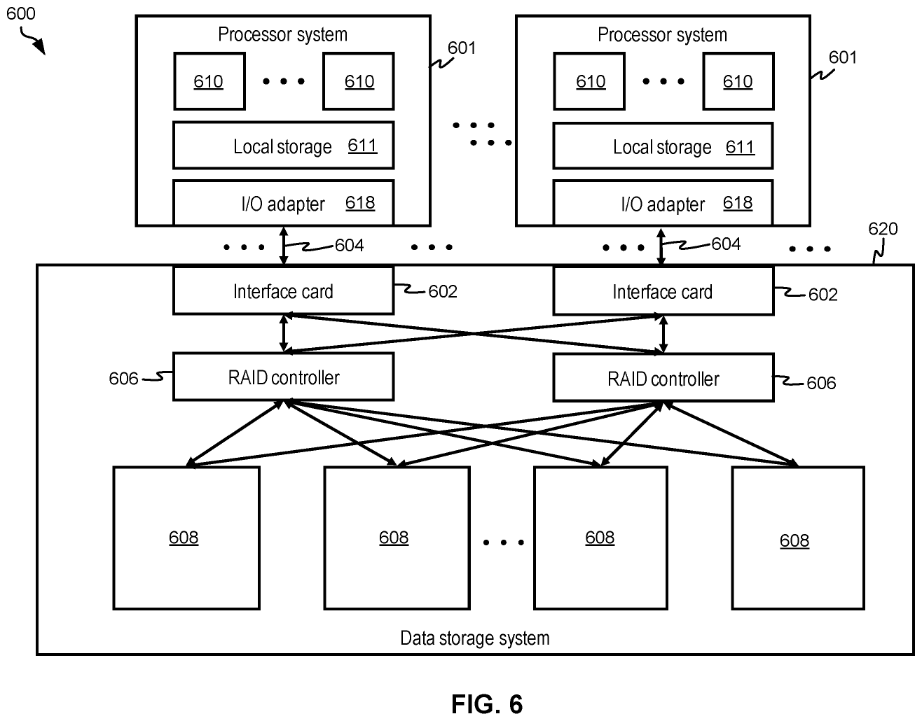

As previously mentioned, memory card 500 may be implemented in various types of data storage systems, depending on the desired embodiment. FIG. 6 illustrates a data storage system architecture 600 according to an exemplary embodiment which is in no way intended to limit the invention. Moreover, it should be noted that the data storage system 620 of FIG. 6 may include various components found in the embodiment of FIG. 5.

Looking to FIG. 6, the data storage system 620 comprises a number of interface cards 602 configured to communicate via I/O interconnections 604 to one or more processor systems 601. The data storage system 620 may also comprise one or more RAID controllers 606 configured to control data storage in a plurality of non-volatile data storage cards 608. The non-volatile data storage cards 608 may comprise NVRAM, Flash memory cards, RAM, ROM, and/or some other known type of non-volatile memory.

The I/O interconnections 604 may include any known communication protocols, such as Fiber Channel (FC), FC over Ethernet (FCOE), Infiniband, Internet Small Computer System Interface (iSCSI), Transport Control Protocol/Internet Protocol (TCP/IP), Peripheral Component Interconnect Express (PCIe), etc., and/or any combination thereof.

The RAID controller(s) 606 in the data storage system 620 may perform a parity scheme similar to that employed by RAID-5, RAID-10, or some other suitable parity scheme, as would be understood by one of skill in the art upon reading the present descriptions.

Each processor system 601 comprises one or more processors 610 (such as CPUs, microprocessors, etc.), local data storage 611 (e.g., such as RAM 314 of FIG. 3, ROM 316 of FIG. 3, etc.), and an I/O adapter 618 configured to communicate with the data storage system 620.

Referring again to FIG. 5, memory controllers 508, GPP 512, and/or other controllers described herein (e.g., RAID controllers 606 of FIG. 6) may be able to perform various functions on stored data, depending on the desired embodiment. Specifically, memory controllers or GPP 512 may include logic configured to perform any one or more of the following functions, which are in no way intended to be an exclusive list. In other words, depending on the desired embodiment, logic of a storage system may be configured to perform additional or alternative functions, as would be appreciated by one skilled in the art upon reading the present description.

### Garbage Collection

Garbage collection in the context of SSD memory controllers of the present description may include the process of identifying blocks of data to be reclaimed for future usage and relocating all pages that are still valid therein. Moreover, depending on the specific controller and/or the respective garbage collection unit of operation, logic erase blocks (LEBs) may be identified for being reclaimed and/or relocated. Typically, one LEB corresponds to one block stripe, but alternative implementations may consider a fixed number of block stripes or a single block building a LEB as well.

A physical “block” represents a minimal unit that may be erased on non-volatile memory, e.g., such as NAND Flash memory, and thereby prepared for writing data thereto. However, a typical garbage collection unit of operation is often a multiple of the physical blocks of non-volatile memory, and is also referred to herein as a LEB. This is due to the fact that typically RAID-like parity information is added in LEBs. Therefore, in case of a page or block failure data can only be rebuilt when all blocks in the LEB are still holding data. Accordingly, the individual blocks from the garbage collection unit can only be erased either individually or in a single unit once all still valid data from all blocks in the LEB has been relocated successfully to new locations. Hence, the full garbage collection units are garbage-collected as a single unit. Moreover, the size of the LEB directly affects the garbage collection induced write amplification. The larger the LEB, the more likely it becomes that unrelated data are stored together in the LEB, and therefore more of the LEB data may have to be relocated upon garbage collection selection.

Frequently, blocks from different dies and/or flash channels are grouped together, such that blocks from the same group can be read or written in parallel, thereby increasing overall bandwidth. It is also possible to combine the previous two methods, and to compose RAID stripes using blocks from different flash channels that can be accessed in parallel.

It should also be noted that an LEB may include any multiple of the physical memory block, which is a unit of physical erasure. Moreover, the organization of memory blocks into LEBs not only allows for adding RAID-like parity protection schemes among memory blocks from different memory chips, memory planes and/or channels but also allows for significantly enhancing performance through higher parallelism. For instance, multiple non-volatile memory blocks may be grouped together in a RAID stripe. As will be appreciated by one skilled in the art upon reading the present description, RAID schemes generally improve reliability and reduce the probability of data loss.

According to an exemplary embodiment, which is in no way intended to limit the invention, memory controllers (e.g., see 508 and/or GPP 512 of FIG. 5) may internally perform a garbage collection. As previously mentioned, the garbage collection may include selecting a LEB to be relocated, after which all data that is still valid on the selected LEB may be relocated (e.g., moved). After the still valid data has been relocated, the LEB may be erased and thereafter, used for storing new data. The amount of data relocated from the garbage collected LEB determines the write amplification. Moreover, an efficient way to reduce the write amplification includes implementing heat segregation.

### Heat Segregation

In the present context, the “write heat” of data refers to the rate (e.g., frequency) at which the data is updated (e.g., rewritten with new data). Memory blocks that are considered “hot” tend to have a frequent updated rate, while memory blocks that are considered “cold” have an update rate slower than hot blocks.

Tracking the write heat of a logical page may involve, for instance, allocating a certain number of bits in the LPT mapping entry for the page to keep track of how many write operations the page has seen in a certain time period or window. Typically, host write operations increase the write heat whereas internal relocation writes decrease the write heat. The actual increments and/or decrements to the write heat may be deterministic or probabilistic.

Similarly, read heat may be tracked with a certain number of additional bits in the LPT for each logical page. To reduce meta-data, read heat can also be tracked at a physical block level where separate counters per block for straddling and non-straddling reads can be maintained. However, it should be noted that the number of read requests to and/or read operations performed on a memory block may not come into play for heat segregation when determining the heat of the memory block for some embodiments. For example, if data is frequently read from a particular memory block, the high read frequency does not necessarily mean that memory block will also have a high update rate. Rather, a high frequency of read operations performed on a given memory block may denote an importance, value, etc. of the data stored in the memory block.

By grouping memory blocks of the same and/or similar write heat values, heat segregation may be achieved. In particular, heat segregating methods may group hot memory pages together in certain memory blocks while cold memory pages are grouped together in separate memory blocks. Thus, a heat segregated LEB tends to be occupied by either hot or cold data.

The merit of heat segregation is two-fold. First, performing a garbage collection process on a hot memory block will prevent triggering the relocation of cold data as well. In the absence of heat segregation, updates to hot data, which are performed frequently, also results in the undesirable relocations of all cold data collocated on the same LEB as the hot data being relocated. Therefore, the write amplification incurred by performing garbage collection is much lower for embodiments implementing heat segregation.

Secondly, the relative heat of data can be utilized for wear leveling purposes. For example, hot data may be placed in healthier (e.g., younger) memory blocks, while cold data may be placed on less healthy (e.g., older) memory blocks relative to those healthier memory blocks. Thus, the rate at which relatively older blocks are exposed to wear is effectively slowed, thereby improving the overall endurance of a given data storage system implementing heat segregation.

### Write Allocation

Write allocation includes placing data of write operations into free locations of open LEBs. As soon as all pages in a LEB have been written, the LEB is closed and placed in a pool holding occupied LEBs. Typically, LEBs in the occupied pool become eligible for garbage collection. The number of open LEBs is normally limited and any LEB being closed may be replaced, either immediately or after some delay, with a fresh LEB that is being opened.

During performance, garbage collection may take place concurrently with user write operations. For example, as a user (e.g., a host) writes data to a device, the device controller may continuously perform garbage collection on LEBs with invalid data to make space for the new incoming data pages. As mentioned above, the LEBs having the garbage collection being performed thereon will often have some pages that are still valid at the time of the garbage collection operation; thus, these pages are preferably relocated (e.g., written) to a new LEB.

Again, the foregoing functions are in no way intended to limit the capabilities of any of the storage systems described and/or suggested herein. Rather, the aforementioned functions are presented by way of example, and depending on the desired embodiment, logic of a storage system may be configured to perform additional or alternative functions, as would be appreciated by one skilled in the art upon reading the present description.

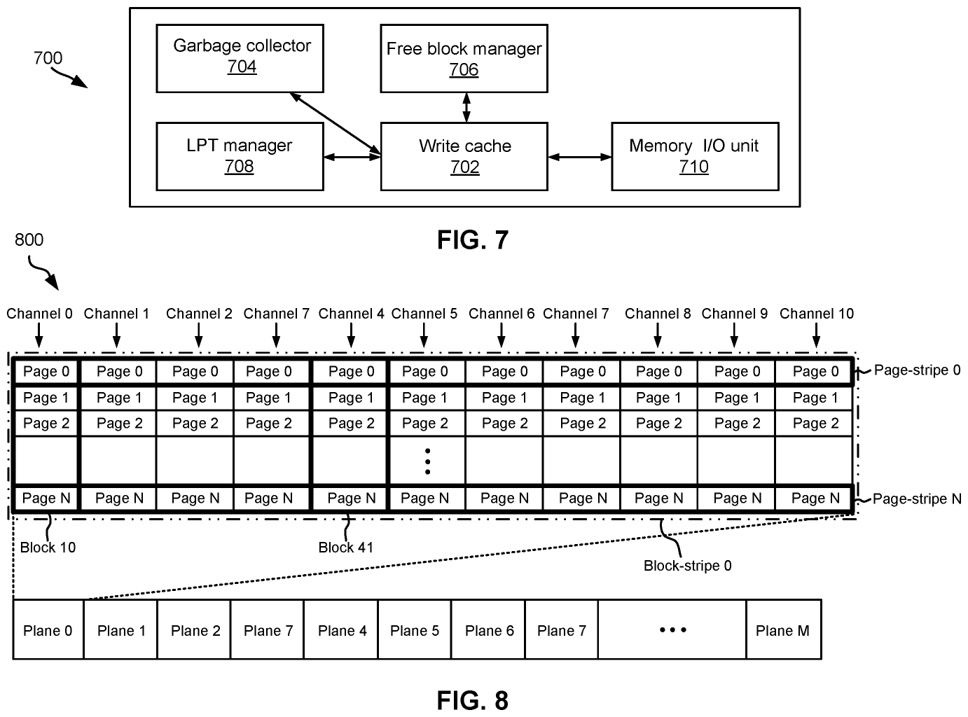

Referring now to FIG. 7, a system 700 is illustrated in accordance with one embodiment. As an option, the present system 700 may be implemented in conjunction with features from any other embodiment listed herein, such as those described with reference to the other FIGS. However, such system 700 and others presented herein may be used in various applications and/or in permutations which may or may not be specifically described in the illustrative embodiments listed herein. Further, the system 700 presented herein may be used in any desired environment, e.g., in combination with a controller.

As illustrated, system 700 includes a write cache 702 which is coupled to several other components, including garbage collector 704. As previously mentioned, garbage collector 704 may be used to free LEB units by relocating valid data and providing non-volatile memory blocks to be erased for later reuse. Thus, the garbage collector 704 may reclaim blocks of consecutive physical space, depending on the desired embodiment. According to an exemplary embodiment, block erase units may be used to keep track of and/or complete the erase of non-volatile memory blocks handed over by the garbage collector 704.

Write cache 702 is also coupled to free block manager 706 which may keep track of free non-volatile memory blocks after they have been erased. Moreover, as would be appreciated by one of ordinary skill in the art upon reading the present description, the free block manager 706 may build free stripes of non-volatile memory blocks from different lanes (e.g., block-stripes) using the erased free non-volatile memory blocks.

Referring still to FIG. 7, write cache 702 is coupled to LPT manager 708 and memory I/O unit 710. The LPT manager 708 maintains the logical-to-physical mappings of logical addresses to physical pages in memory. According to an example, which is in no way intended to limit the invention, the LPT manager 708 may maintain the logical-to-physical mappings of 4 KiB or 16 KiB logical addresses. The memory I/O unit 710 communicates with the memory chips in order to perform low level operations, e.g., such as reading one or more non-volatile memory pages, writing a non-volatile memory page, erasing a non-volatile memory block, etc.

To better understand the distinction between block-stripes and page-stripes as used herein, FIG. 8 is a conceptual diagram 800, in accordance with one embodiment. LEBs are built from block stripes and typically a single block stripe is used to build a LEB. However, alternative embodiments may use multiple block stripes to form an LEB. As an option, the present conceptual diagram 800 may be implemented in conjunction with features from any other embodiment listed herein, such as those described with reference to the other FIGS. However, such conceptual diagram 800 and others presented herein may be used in various applications and/or in permutations which may or may not be specifically described in the illustrative embodiments listed herein. Further, the controller conceptual diagram 800 presented herein may be used in any desired environment. Thus, the exemplary non-volatile memory controller conceptual diagram 800 of FIG. 8 may be implemented in a cache architecture. However, depending on the desired embodiment, the conceptual diagram 800 of FIG. 8 may be implemented in defining the organization of data stored in non-volatile memory. Accordingly, both implementations are described in turn below.

### Non-Volatile Memory

Looking now to FIG. 8, the conceptual diagram 800 includes a set of M+1 aggregated planes labeled “Plane 0” through “Plane M”. An aggregated plane consists of all physical planes with the same plane index on different channels. It should be noted that aggregated planes are also referred to herein simply as planes.

When implemented with data stored in non-volatile memory, each physical plane on a channel may include a large set of blocks, e.g., typically in the order of 1024, 2048 or more. Moreover, one or more physical planes may also include several additional blocks which may be used as replacement blocks for bad blocks (e.g., blocks performing poorly, blocks having undesirable characteristics, etc.).

In each plane of non-volatile memory, a single block from each channel may form a respective block-stripe. It follows that a number of block-stripes supported by a given embodiment of non-volatile memory may be determined by the number of blocks per plane and the number of planes.

In the exploded view of Plane 0, the conceptual diagram 800 further illustrates a single block-stripe (Block-stripe 0) out of the set of block-stripes supported in the remainder of the planes. Block-stripe 0 of plane 0 is shown as including 11 blocks, one block from each channel labeled “Channel 0” through “Channel 10”. It should be noted that the association of blocks to block-stripe can change over time as block-stripes are typically dissolved after they have been garbage collected. Erased blocks may be placed in free block pools, whereby new block-stripes are assembled from blocks in the free block pools when write allocation requests fresh block-stripes. For example, looking to conceptual diagram 800, Block 10 from Channel 0 and Block 41 from Channel 4 are currently associated with the illustrated Block-stripe 0 of Plane 0. Furthermore, the illustrated Block-stripe 0 holds N+1 page-stripes and each block therefore holds N+1 pages labeled “Page 0” through “Page N”.

### Cache Architecture

Referring still to FIG. 8, each block of pages illustrated in the exploded view of aggregated Plane 0 may constitute a unique block from one channel when implemented in a cache architecture. Similarly, each channel contributes a single, individual block which form a block-stripe. For example, looking to conceptual diagram 800, Block 10 from Channel 0 includes all pages (Page 0 through Page N) therein, while Block 41 from Channel 4 corresponds to all pages therein, and so on.

In the context of a memory controller, e.g., which may be capable of implementing RAID at the channel level, a block-stripe is made up of multiple blocks which amount to a stripe of blocks. Looking still to FIG. 8, the multiple blocks of aggregated Plane 0 constitute Block-stripe 0. While all blocks in a block-stripe typically belong to the same aggregated plane, in some embodiments one or more blocks of a block-stripe may belong to different physical planes. It follows that each aggregated plane may include one or more block-stripe. Thus, according to an illustrative embodiment, Block 0 through Block 10 from different physical planes may constitute a block-stripe.

Regardless of whether the conceptual diagram 800 of FIG. 8 is implemented with non-volatile memory and/or a cache architecture, in different embodiments, the number of pages in each block and/or the number of channels in each plane may vary depending on the desired embodiment. According to an exemplary embodiment, which is in no way intended to limit the invention, a block may include 256 pages, but could include more or fewer in various embodiments. Analogously, the number of channels per plane and/or the number of planes may vary depending on the desired embodiment.

Referring still to FIG. 8, all pages in a block-stripe with the same page index denote a page-stripe. For example, Page-stripe 0 includes the first page (Page 0) of each channel in Block-stripe 0 of Plane 0. Similarly, Page-stripe N includes the last page (Page N) of each channel in Block-stripe 0 of Plane 0.

### Fast Fill

Flash drive capacities continue to grow due to market demands and denser chips. With these larger capacities, the time to fill a drive with data also increases. Thus, processes such as testing full drives take a correspondingly longer amount of time to perform. Drives filled to some reasonable level, to mimic real-world conditions, would be desirable for a myriad of quality assurance processes as well as for measuring real-world performance after preconditioning of the drive.

Presented below is a methodology for a fast fill process for an SSD that in turn enables completion of processes, such as quality assurance and performance testing, much more quickly, thereby saving significant testing time and/or resources. The approaches presented below are particularly beneficial in that they allow the various steps in testing, such as preconditioning, to take place via the normal, operational mechanisms of the drive, and in much less time than compared to known methods of testing.

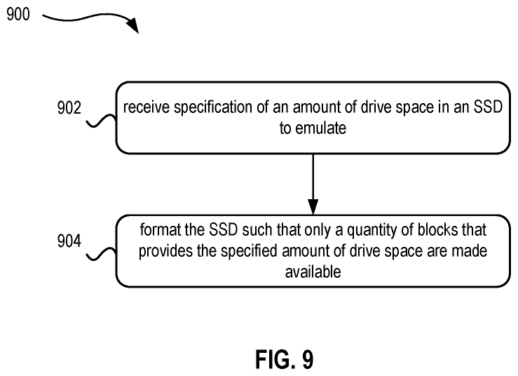

Now referring to FIG. 9, a flowchart of a method 900 is shown according to one embodiment. The method 900 may be performed in accordance with the present invention in any of the environments depicted in FIGS. 1-8, among others, in various embodiments. Of course, more or fewer operations than those specifically described in FIG. 9 may be included in method 900, as would be understood by one of skill in the art upon reading the present descriptions.

Each of the steps of the method 900 may be performed by any suitable component of the operating environment. For example, in various embodiments, the method 900 may be partially or entirely performed by an SSD, a test computer, a storage controller, or some other device having one or more processors therein. The processor, e.g., processing circuit(s), chip(s), and/or module(s) implemented in hardware and/or software, and preferably having at least one hardware component, may be utilized in any device to perform one or more steps of the method 900. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 9, method 900 may initiate with operation 902, which includes receiving specification of an amount of drive space (storage space) in an SSD to emulate. The specified amount is less than all (i.e., less than 100%) of the total drive space of the SSD that would otherwise be available for data operations. The amount may be specified as a percentage or equivalent number in some embodiments. In other embodiments, the amount may be specified in terms of storage capacity, e.g., 800 gigabytes.

Preferably, the specified amount of drive space to emulate is less than 90%, and more preferably less than 81% of the drive space, though any amount less than 100% will achieve time savings.

Also preferably, the specified amount of drive space to emulate is 50% of the drive space or greater, though a lower percentage (e.g., 30%, 40%, etc.) can be specified if desired.

Note that the lower the specified percentage, the more chance there is for an errant defect to not be discovered during testing. Nonetheless, the inventors have found via experimentation that a specified amount of 50% to 80% provides a good balance between relatively accurate results and time savings.

In operation 904, the SSD is formatted such that only a quantity of blocks that provides the specified amount of drive space are made available. The other blocks are skipped (e.g., are ignored, not formatted, marked for nonuse, etc.). Preferably, a presented amount of drive space of the SSD corresponds to the specified amount of drive space. The presented amount of drive space may, in some approaches, be determined by scaling an actual amount of drive space in the SSD according to the specified percentage. For example, if the specified amount corresponds to 80% of an approximately 1 terabyte SSD, the amount of drive space presented by the drive will be approximately 800 gigabytes. Because the drive presents the amount of storage capacity according to the specified amount, the testing system considers the drive to have only presented amount of capacity; thus, the testing system does not need to be configured any differently for operating on drives modified according to the method 900, in preferred approaches.

The available blocks are preferably distributed substantially evenly across planes of the SSD to provide the best sampling of the blocks across the entire drive. However, any distribution desired by the user may be selected.

Parameters of the SSD that are dependent upon capacity are scaled based on the specified amount of drive space relative to an actual amount of drive space of the SSD. Such parameters that may be scaled may include the system cache and its eviction threshold; ratios, tables and metadata; etc. Thus, for example, a specified amount corresponding to 80% of the drive space would result in the system cache being limited to approximately 80% of its usable size. Likewise, other background processes such as garbage collection triggering thresholds, etc. may be scaled according to the specified amount. In this way, the internal behavior of the drive with the lower specified amount of capacity is essentially the same as if the drive were operating at full capacity.

Upon device format, the Quick Fill method sets aside a user-defined percentage of the available storage blocks for normal operation and discards the others. Once enabled, filling the drive and preconditioning the drive takes a fraction of time on par with the specified percentage (i.e., using only 50% of storage blocks allows the drive to be filled or preconditioned in half the time). Alongside careful implementation inside the flash controlling firmware, the storage device can behave nearly identically to the way an unmodified storage device would behave.

The memory of the SSD may be configured as single-level cell (SLC) memory, capable of storing one bit per cell, and two possible voltage states. In other approaches, the memory of the SSD may be configured to have multiple levels, such as multi-level cell (MLC) memory capable of storing two bits per cell, according to four possible voltage states. Further approaches include configuration to operate as triple-level cell (TLC) memory, capable of storing three bits per cell, according to eight possible voltage states; or quad-level cell (QLC) memory capable of storing four bits per cell, according to 16 possible voltage states.

In some aspects, the SSD may be configured to operate with two or more of the foregoing memory configurations, such as SLC and QLC. For example, a drive may be configured with some portion thereof configured as SLC to achieve faster performance using such cells, while another portion thereof is configured as QLC to achieve high data storage density for the portion of the drive using QLC. In such case, the method 900 preferably includes enforcing an unmodified card SLC/QLC ratio among the blocks. Thus, for example, if a drive is nominally configured as 40% SLC and 60% QLC, and the specified quantity is 70%, the drive would retain the 40% to 60% SLC/QLC ratio after the reduction in capacity thereof to 70%. Preferably, the skipped blocks are marked so that a SLC and QLC Pools (SQP) engine ignores the skipped blocks.

### Testing Procedure Using Fast Fill

Testing of drives is desirable for a plethora of reasons, such as to ensure reliability; to detect problems with the drives such as bad cells, firmware issues, etc.; determination of performance measurements and statistics; and so on. As mentioned above, testing a drive filled with data takes an extremely long time, especially for larger capacity drives.

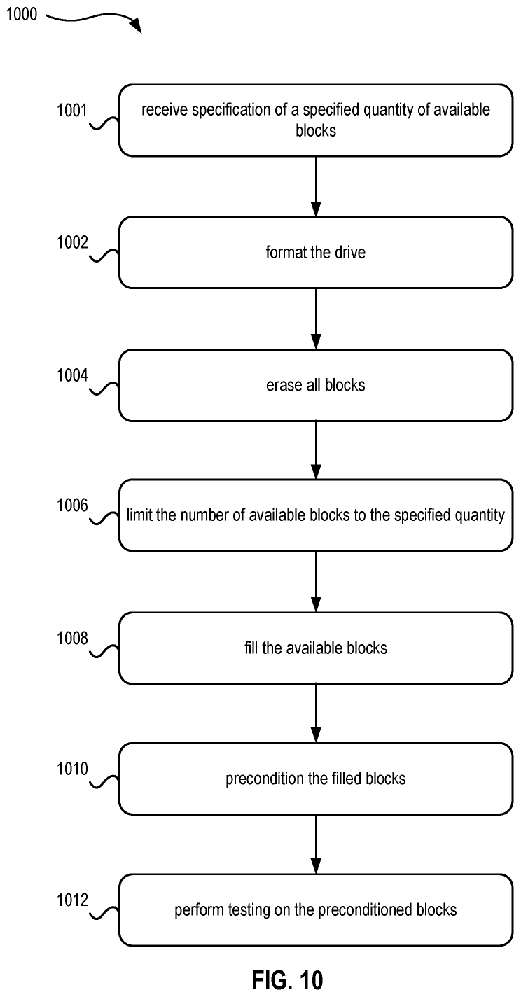

Now referring to FIG. 10, a flowchart of a testing method 1000 is shown according to one embodiment. The method 1000 may be performed in accordance with the present invention in any of the environments depicted in FIGS. 1-9, among others, in various embodiments. Of course, more or fewer operations than those specifically described in FIG. 10 may be included in method 1000, as would be understood by one of skill in the art upon reading the present descriptions.

Each of the steps of the method 1000 may be performed by any suitable component of the operating environment. For example, in various embodiments, the method 1000 may be partially or entirely performed by an SSD, a storage controller, a testing apparatus in communication with an SSD, or some other device having one or more processors therein. The processor, e.g., processing circuit(s), chip(s), and/or module(s) implemented in hardware and/or software, and preferably having at least one hardware component, may be utilized in any device to perform one or more steps of the method 1000. Illustrative processors include, but are not limited to, a central processing unit (CPU), an application specific integrated circuit (ASIC), a field programmable gate array (FPGA), etc., combinations thereof, or any other suitable computing device known in the art.

The method 1000 generally includes operation 1001, where a specified quantity of available blocks is received, e.g., as in operation 902 of FIG. 9.

In operation 1002, where the drive is formatted. In some approaches, all blocks are formatted.

In operation 1004, all blocks are erased.

In operation 1006, the number of available blocks is limited to the specified quantity, e.g., by performing the method 900 of FIG. 9. In some approaches, this operation is performed before operations 1002-1004, and only the available blocks are formatted and erased. As noted above, the remaining available blocks are preferably distributed evenly across the planes.

In operation 1008, the available blocks are filled to some extent, up to 100% or some lesser percentage, e.g., with dummy data, test data, etc. The unavailable blocks are ignored. Note that, in most cases, the available blocks are not filled to 100%. They may need some extra available space to help maintain internal garbage collection as well as modify any logical block addresses (LBAs) with new data.

In operation 1010, the filled blocks are preconditioned. Any preconditioning technique that would become apparent to one skilled in the art after reading the present disclosure may be performed. In one approach, preconditioning includes performing read, write, erase, overwrite, etc. operations on the available blocks, e.g., according to a predefined testing procedure, to simulate real world use, etc. The preconditioning may proceed according to a testing specification.

In operation 1012, testing is performed on the preconditioned blocks. Any testing technique that would become apparent to one skilled in the art after reading the present disclosure may be performed. In one approach, the testing may include measuring performance of the drive. Preferably, the presented capacity is treated as if it were the actual capacity of the drive.

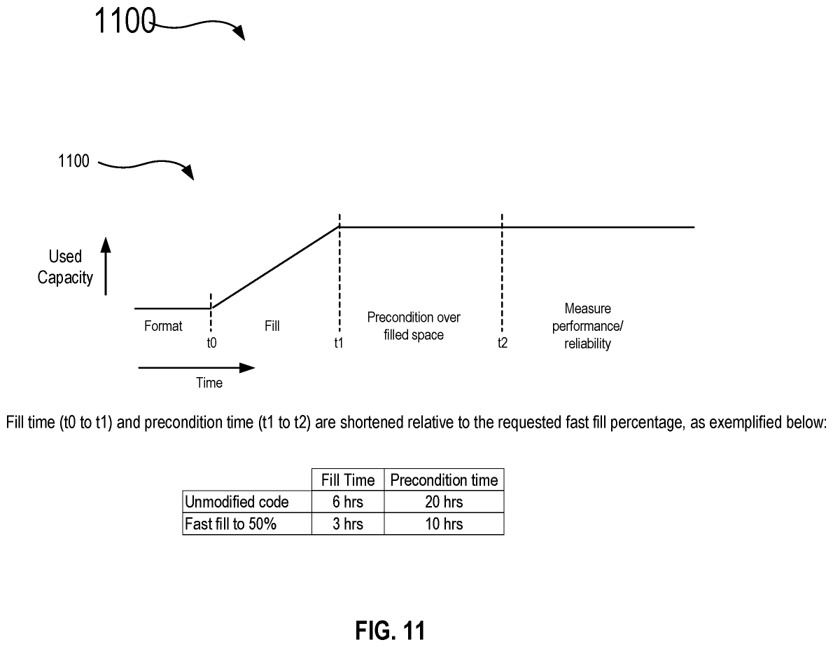

FIG. 11 is a chart 1100 depicting an exemplary the timeline of the method of FIG. 10, and the time saved using the fast fill method presented herein relative to testing an entire drive at full capacity. In the chart 1100, t0 corresponds to the end of operation 1006. As shown in the chart 1100, selection of 50% block availability cuts at least the fill time and preconditioning time approximately in half. The corresponding testing time is also generally cut in half.

After testing is completed, the drive may be reconfigured to operate using its nominal settings and capacity. For example, the drive may be reformatted or reprogrammed to make all usable blocks and the entire system cache available for data storage.

Note also that any of the foregoing methodology may be performed for an array of SSDs, where the specified percentage is applied across the array of drives.

A system configured to perform the foregoing methodology may include a plurality of non-volatile random access memory (NVRAM) blocks configured to store data, and a processor (e.g., controller) and logic integrated with and/or executable by the processor, the logic being configured to perform the foregoing method. As an option, such present system may be implemented in conjunction with features from any other embodiment listed herein, such as those described with reference to the other FIGS. Of course, however, such system and others presented herein may be used in various applications and/or in permutations which may or may not be specifically described in the illustrative embodiments listed herein. Further, the system presented herein may be used in any desired environment.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving specification of an amount of drive space in a solid state drive (SSD) to emulate, the specified amount being less than all of the drive space of the SSD; and
formatting the SSD such that only a number of blocks that provides the specified amount of drive space are made available, wherein the other blocks are skipped, wherein the available blocks are distributed substantially evenly across planes of the SSD,
wherein a presented amount of drive space of the SSD corresponds to the specified amount of drive space, and
wherein parameters of the SSD that are dependent upon capacity are scaled based on the specified amount of drive space relative to an actual amount of drive space of the SSD.

2. The method of claim 1, wherein the specified amount of drive space to emulate is less than 81%.

3. The method of claim 2, wherein the specified amount of drive space to emulate is at least 50%.

4. The method of claim 1, comprising enforcing an unmodified card single level cell (SLC)/quad level cell (QLC) ratio among the blocks.

5. The method of claim 4, wherein the skipped blocks are marked so that a SLC and QLC Pools (SQP) engine ignores the skipped blocks.

6. The method of claim 1, wherein the specification is received as a percentage, wherein the presented amount of drive space is determined by scaling an actual amount of drive space in the SSD according to the percentage.

7. The method of claim 1, comprising filling the available blocks.

8. The method of claim 7, comprising preconditioning the filled blocks.

9. The method of claim 8, comprising performing testing on the preconditioned blocks.

10. A system, comprising:
a plurality of non-volatile random access memory (NVRAM) blocks configured to store data; and
a processor and logic integrated with and/or executable by the processor, the logic being configured to:
receive specification of an amount of drive space in a solid state drive (SSD) to emulate, the specified amount being less than all of the drive space of the SSD; and
format the SSD such that only a number of blocks that provides the specified amount of drive space are made available, wherein the other blocks are skipped,
wherein the available blocks are distributed substantially evenly across planes of the SSD,
wherein a presented amount of drive space of the SSD corresponds to the specified amount of drive space, and
wherein parameters of the SSD that are dependent upon capacity are scaled based on the specified amount of drive space relative to an actual amount of drive space of the SSD.

11. The system of claim 10, wherein the specified amount of drive space to emulate is less than 81%.

12. The system of claim 11, wherein the specified amount of drive space to emulate is at least 50%.

13. The system of claim 10, comprising enforcing an unmodified card single level cell (SLC)/quad level cell (QLC) ratio among the blocks.

14. The system of claim 13, wherein the skipped blocks are marked so that a SLC and QLC Pools (SQP) engine ignores the skipped blocks.

15. The system of claim 10, wherein the specification is received as a percentage, wherein the presented amount of drive space is determined by scaling an actual amount of drive space in the SSD according to the percentage.

16. The system of claim 10, wherein the logic is configured to fill the available blocks.

17. The system of claim 16, wherein the logic is configured to precondition the filled blocks.

18. The system of claim 17, wherein the logic is configured to perform testing of the preconditioned blocks.

19. A computer program product, the computer program product comprising:
one or more computer readable storage media, and program instructions collectively stored on the one or more computer readable storage media, the program instructions comprising:
program instructions to receive specification of an amount of drive space in a solid state drive (SSD) to emulate, the specified amount being less than all of the drive space of the SSD; and
program instructions to format the SSD such that only a number of blocks that provides the specified amount of drive space are made available, wherein the other blocks are skipped,
wherein the available blocks are distributed substantially evenly across planes of the SSD,
wherein a presented amount of drive space of the SSD corresponds to the specified amount of drive space, and
wherein parameters of the SSD that are dependent upon capacity are scaled based on the specified amount of drive space relative to an actual amount of drive space of the SSD.

20. The computer program product of claim 19, wherein the specified amount of drive space to emulate is at least 50% and less than 81%.
